(19) United States
(12) Patent Application Publication
(10) Pub. No.: US 2017/0112076 A1
(43) Pub. Date: Apr. 27, 2017

(54) Plant Limb Root Germination Method and Apparatus

(71) Applicant: Don Christopher Kotter, SR., Mandeville, LA (US)

(72) Inventor: Don Christopher Kotter, SR., Mandeville, LA (US)

(21) Appl. No.: 15/331,611

(22) Filed: Oct. 21, 2016

Related U.S. Application Data
(60) Provisional application No. 62/245,094, filed on Oct. 22, 2015.

(51) Int. Cl. A01G 17/00; A01G 1/00

(52) U.S. Cl. CPC A01G 17/00; A01G 1/001

(57) ABSTRACT

Exemplary embodiments provide an apparatus and method of use for more easily and reliably stimulating root growth on the limbs of plants or trees. The apparatus securely locks in place around a limb of a tree, and a root growth medium is placed inside the apparatus around a limb of a plant or tree. A watering tube and viewing port are also provided. After a period of time, roots grow inside the root growth medium, the apparatus is removed, the limb is severed from the plant or tree, and the limb and newly-formed root ball are planted.

### CROSS-REFERENCE TO RELATED APPLICATIONS

This application claims priority from U.S. Provisional Application No. 62/245,094 (Kotter), filed Oct. 22, 2015, which is incorporated herein by reference as if set forth in full below.

### BACKGROUND OF THE INVENTION

The present invention relates to a method and apparatus for germinating roots on the limbs of live plants, particularly, trees and bushes.

Many types of plant limbs will grow roots when covered in a moist environment; and this principle has been used to propagate plants. Previous efforts to propagate plants include placing plastic containers, sheets of plastic, coffee cans, or aluminum foil filled with a suitable growth medium, such as sphagnum peat moss, around a branch of a tree or plant, keeping the growth medium moist, waiting until roots grown in the growth medium, and then removing and planting the branch. However, these methods and apparatuses are difficult to use, not reusable, susceptible of falling off of a tree or plant in heavy wind, can damage plants, or create irregularly shaped root balls. In view of these problems, disclosed herein is an improved plant limb root germination method and apparatus which solves these problems by being easily and sturdily attachable to a limb of a tree or plant to create a tight seal on a trees or plants of varying sizes to create a uniform regular shaped root ball, while still being easy to water, remove and reuse. The rigidity and locking mechanism disclosed herein provide a plant limb root germination apparatus which is sturdy to the environment which is capable of remaining on a limb of a plant or tree, even in relatively high winds. The hinged operation disclosed herein provides a plant limb root germination apparatus which is capable of fitting around a limb of a plant or tree, even if said plant limb is very long or is larger than the diameter of the provided openings. The watertight seal disclosed herein provide for water to remain inside of a plant limb root germination apparatus, reducing the potential for the interior root growth medium to become too try to promote root growth.

### SUMMARY OF THE INVENTION

Disclosed herein is a container that can be attached around a plant or tree limb and filled with moss and water to germinate roots, as well as a method of using said container. After approximately six to twelve weeks, and after roots germinate, the plant or tree limb may be severed and planted.

Also disclosed herein is a plant limb root germination apparatus comprising a first wall and a second wall, said first wall further comprising, a first top indentation, a first bottom indentation, and a first edge; and said second wall further comprising a second top indentation, a second bottom indentation, and a second edge; wherein said first wall and said second wall are hingedly connected on a first side and detachably connected on a second side; and wherein when said first wall and said second wall are closed, said first wall and said second wall form an interior cavity, said first top indentation and said second top indentation form a top opening, and said first bottom indentation and said second bottom indentation form a bottom opening; wherein said interior cavity is capable of holding a root growth medium, further comprising a locking mechanism which locks said first side and said second side together, wherein said first wall and said second wall are rigid, opaque, and non-permeable to water wherein either said first edge or said second edge is a first cushioned surface, wherein when said first wall and said second wall are locked together, said first cushioned surface creates a watertight seal between said first edge and said second edge, wherein said first wall further comprises a viewing port and a watering tube, wherein said first top indentation further comprises a first top indentation edge, said second top indentation further comprises a second top indentation edge, said first bottom indentation further comprises a first bottom indentation edge, and said second bottom indentation further comprises a second bottom indentation edge; and wherein each of said first top indentation edge, said second top indentation edge, said first bottom indentation edge, said second bottom indentation edge are cushioned surfaces.

Also disclosed herein is a method of creating and using a plant limb root germination apparatus, comprising the steps of: three-dimensionally printing a plant limb root germination apparatus comprising a first concave wall and a second concave wall, wherein said first concave wall and said second concave wall are hingedly and detachably connected and when closed form an interior cavity, a top opening, and a bottom opening; filling said interior cavity of said plant limb root germination apparatus with a root growth medium; attaching said plant limb root germination apparatus to a branch of a plant; monitoring said root growth medium for root growth from said branch of said plant until a root ball forms in said root growth medium; cutting said branch below said root ball; and planting said root ball; wherein said plant limb root germination apparatus is three dimensionally printed to dimensions appropriate for said branch of said plant; wherein said plant limb root germination apparatus is rigid, opaque, and non-permeable to water; wherein said first concave wall further comprises a viewing port and wherein said monitoring step further comprises adding an additional root growth medium into said interior cavity; wherein said first concave wall further comprises a watering tube and said monitoring step further comprises a substep of maintaining moisture in said root growth medium in said interior cavity by adding water into said interior cavity by pouring water into said viewing port or said watering tube; wherein said plant root limb germination apparatus further comprises a locking mechanism and said attaching step further comprises the step of locking said plant root limb germination apparatus; wherein the step of locking said plant root limb germination apparatus securely fastens said plant root limb germination apparatus to said branch of said plant.

### BRIEF DESCRIPTION OF THE DRAWINGS

FIG. 1 is a perspective view showing the exterior of an opened plant limb root germination apparatus.

FIG. 2 is a perspective view showing the interior of an opened plant limb root germination apparatus.

FIG. 3 is a perspective view of a closed plant limb root germination apparatus.

FIG. 4 is an alternate perspective view of a closed plant limb root germination apparatus.

FIG. 5 is a reverse perspective view of a closed plant limb root germination apparatus.

FIG. 6 illustrates a portion of a method of using a plant limb root germination apparatus by illustrating a plant limb root germination apparatus on a tree.

FIG. 7 illustrates a portion of a method of using a plant limb root germination apparatus by illustrating a small tree after a plant limb root germination apparatus has been removed.

FIG. 8 illustrates a portion of a method of using a plant limb root germination apparatus by illustrating a branch of a small tree which has been removed from said small tree and planted in the ground.

FIG. 9 illustrates a portion of a method of creating and using a plant limb root germination apparatus to scale using a three-dimensional printer.

FIG. 10 depicts a method of creating and using a plant limb root germination apparatus.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION OF THE INVENTION

FIG. 1 illustrates rooter 100. As used herein, the term “rooter” means a plant limb root growth apparatus. FIG. 1 depicts certain features of an exemplary embodiment of rooter 100, namely, first wall 102, second wall 104, viewing port 106, watering tube 108, watering tube hole 110, first top indentation 112, second top indentation 114, first hinge 116, second hinge 118, clasp reception block 120, clasp reception ridge 122, rotating clasp block 124, rotating clasp bar 126, rotating clasp 128, rotating clasp lip 130, first edge 134, second edge 132, first top indentation edge 138, and second top indentation edge 136. Not shown in FIG. 1 are second bottom indentation edge 140, first bottom indentation edge 142, second bottom indentation 144, first bottom indentation 146, second wall (interior) 148, first wall (interior) 150, top opening 152, bottom opening 154, and interior cavity 180.

In an exemplary embodiment, rooter 100 is comprised of a thermoplastic polymer such as polylactic acid (PLA) and is opaque. Rooter 100 may also be made of expanded polystyrene foam, elastomers, a thermosetting polymer, or other suitable materials. In exemplary embodiments, rooter 100 is comprised of a material that is not permeable to water.

In said exemplary embodiment, rooter 100 is approximately 200.00mm long, 107.72mm wide, and 46.19mm tall, having an approximately ovoid shape. However, other sizes and shapes may be used.

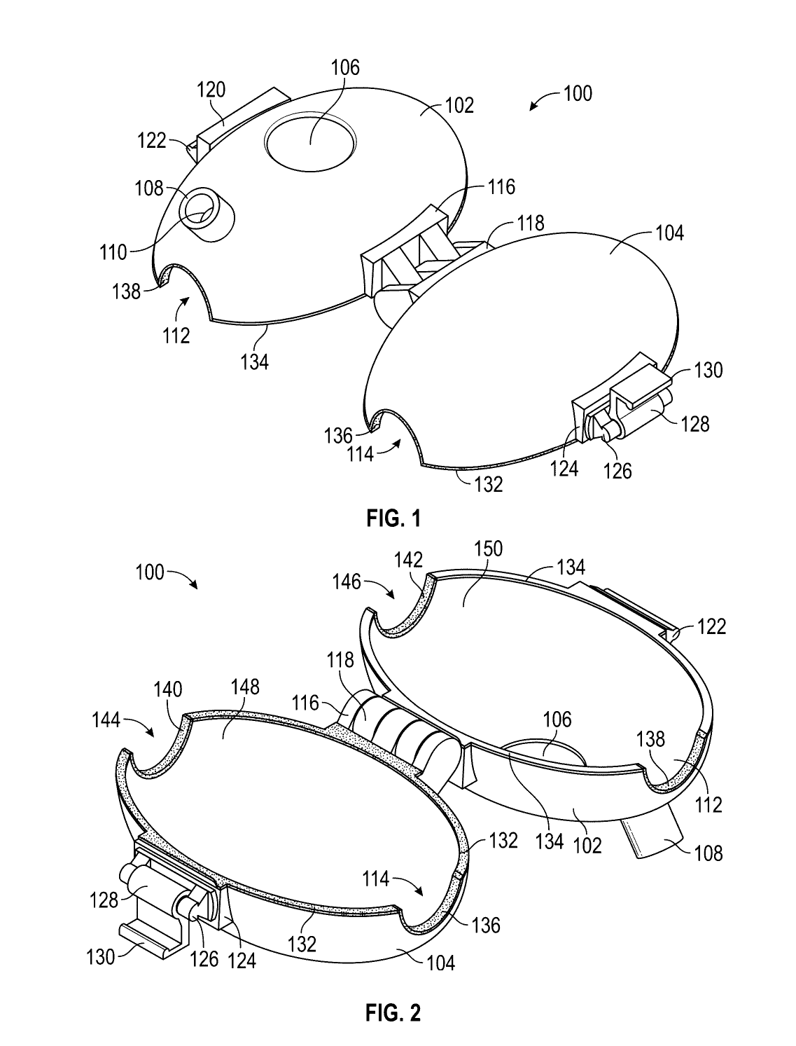

In another exemplary embodiment, rooter 100 is approximately seven inches long as measured between first top indentation 112 and first bottom indentation 146 (shown in FIG. 2) and gradually tapers from approximately four inches wide between clasp reception block 120 and rotating clasp block 124 to approximately one inch wide at first top indentation 112 (and between first top indentation 112 and second top indentation 114 when rooter 100 is closed). However, other sizes and shapes may be used.

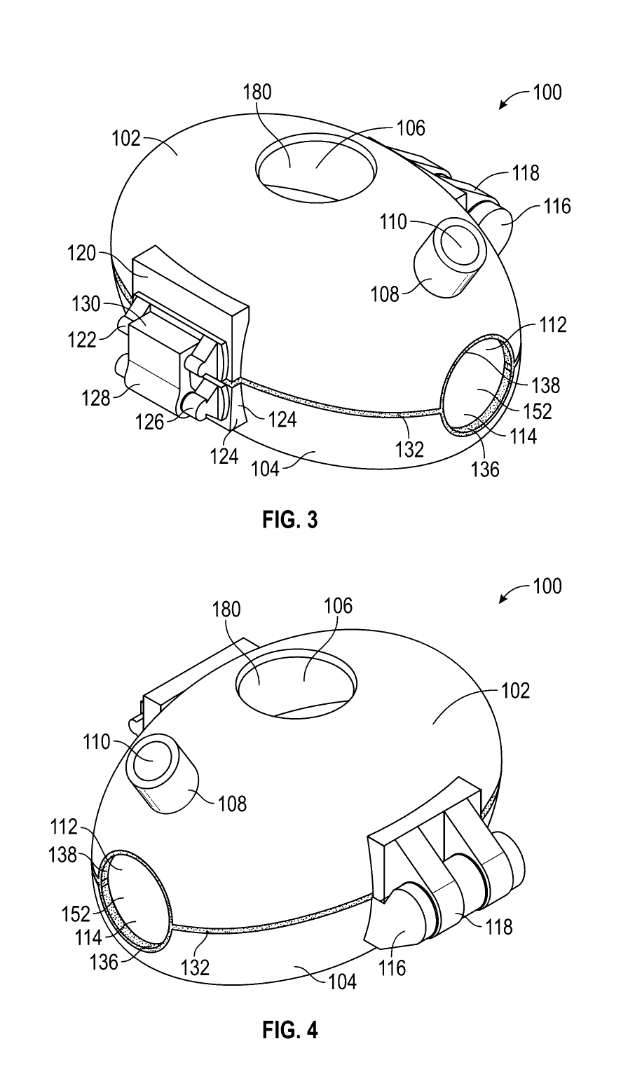

In said exemplary embodiment, first wall 102 further comprises viewing port 106 and watering tube 108, with watering tube 108 further comprising watering tube hole 110. Viewing port 106 is a void in first wall 102 provided for allowing visual and physical access to interior cavity 180 (shown in FIGS. 3 and 4) of rooter 100. Watering tube 108 (in exemplary embodiments, watering tube 108 is a cylinder) surrounds watering tube hole 110 (and, watering tube hole 110 forms a void in first wall 102); and both watering tube 108 and watering tube hole 110 are provided to allow for water to be poured into interior cavity 180 of rooter 100 while rooter 100 is in use. Viewing port 106 is approximately a circle of two inches in diameter; and watering tube hole 110 is approximately a circle of one inch in diameter. However, other sizes and shapes may be used.

In said exemplary embodiment, first wall 102 further comprises first hinge 116, which is located on a side of first wall 102; and second wall 104 further comprises second hinge 118, which is located on a side of second wall 104. First hinge 116 is approximately three inches by one inch at its connection point to first wall 102 and has two members extending outward towards second hinge 118. Second hinge 118 is approximately three inches by one inch at its connection point to second wall 104 and has three members extending outward towards first hinge 116, wherein the two members of first hinge 116 and the three members of second hinge 118 interlock and form an axis of rotation. Thus, first wall 102 and second wall 104 are hingedly connected by first hinge 116 and second hinge 118. Other shapes and sizes may be used for first hinge 116 and second hinge 118. Other hinged connections may be used. Non-hinged flexible connections may also be used.

In said exemplary embodiment, first wall 102 further comprises clasp reception block 120, which itself further comprises clasp reception ridge 122. Clasp reception block 120 is located on a side of first wall 102 opposite first hinge 116. Clasp reception ridge 122 is a raised ridge extending outward from clasp reception block 120.

Second wall 104 further comprises rotating clasp block 124, which itself further comprises rotating clasp bar 126. Rotating clasp block 124 is located on a side of second wall 104 opposite second hinge 118. Rotating clasp block further comprises two members which extend outwards, away from second wall 104 to rotating clasp bar 126. Rotating clasp bar 126 connects said two members of rotating clasp block 124 and is an approximate cylinder having an axis parallel to a lengthwise axis of rooter 100 and also parallel to the axis of rotation formed by first hinge 116 and second hinge 118.

Clasp reception block 120 and rotating clasp block 124 are each approximately three inches long by one inch wide. However, other shapes and sizes may be used. Other clasp mechanisms may be used.

Rooter 100 further comprises rotating clasp 128. Rotating clasp further comprises a cylindrical tubular shape sitting around rotating clasp bar 126. Thus, rotating clasp 128 is rotationally connected to rotating clasp bar 126. Rotating clasp further comprises a first member extending outward, away from rotating clasp bar 126 and a second member extending, at an approximate 90 degree angle away from said first member of rotating clasp 128. Rotating clasp 128 further comprises rotating clasp lip 130, which is a raised area of rotating clasp 128, in particular a raised ridge of said second member of rotating clasp 128.

In said exemplary embodiment, first wall 102 further comprises first top indentation 112, which is a void in first wall 102; and second wall 104 further comprises second top indentation 114, which is a void in second wall 104. First top indentation 112 and second top indentation 114 are each approximately a semicircle of one inch in diameter. However, other shapes and sizes may be used.

First edge 134, second edge 132, first top indentation edge 138, and second top indentation edge 136 are discussed in the description of FIG. 2.

FIG. 2 depicts certain features of an exemplary embodiment of rooter 100, namely, first wall 102, second wall 104, viewing port 106, watering tube 108, first top indentation 112, second top indentation 114, first hinge 116, second hinge 118, clasp reception ridge 122, rotating clasp block 124, rotating clasp bar 126, rotating clasp 128, rotating clasp lip 130, first edge 134, second edge 132, first top indentation edge 138, and second top indentation edge 136, as pointed out in the description of FIG. 1. FIG. 1 and FIG. 2 depict different views of the same exemplary embodiment, but FIG. 2 also depicts first top indentation edge 138, second bottom indentation edge 140, first bottom indentation edge 142, second bottom indentation 144, first bottom indentation 146, second wall (interior) 148, first wall (interior) 150. Not depicted in FIG. 2 are clasp reception block 120, top opening 152, bottom opening 154, and interior cavity 180.

In an exemplary embodiment of rooter 100, first wall 102 further comprises first bottom indentation 146, which is a void in first wall 102; and second wall 104 further comprises second bottom indentation 144, which is a void in second wall 104. First bottom indentation 146 and second bottom indentation 144 are each approximately a semicircle of one inch in diameter. However, other shapes and sizes may be used.

In said exemplary embodiment, first wall 102 further comprises first edge 134, an end to the approximately concave surface of first wall 102, forming an approximate oval; and second wall 104 further comprises second edge 132, an end to the approximately concave surface of second wall 104, also forming an approximate oval. As shown in this exemplary embodiment, second edge 132 is a foam cushioned surface adhesively attached to second wall 104. In other embodiments, first edge 134 is foam cushioned surface adhesively attached to first wall 102. In yet other embodiments, both first edge 134 and second edge 132 are foam cushioned surfaces adhesively attached to first wall 102 or second wall 104, respectively. In exemplary embodiments, the foam cushioned surfaces are not made out of the same material as rooter 100 (i.e., PLA), but rather, out of another material such as urethane foam, neoprene, other open or closed cell foam, rubber, or any suitable cushioned material, with preferred embodiments using water-impermeable materials.

In said exemplary embodiment, first top indentation 112 further comprises first top indentation edge 138; first bottom indentation 146 further comprises first bottom indentation edge 142; second top indentation 114 further comprises second top indentation edge 136; and second bottom indentation 144 further comprises second bottom indentation edge 140. In said exemplary embodiment, first top indentation edge 138 is a foam cushioned surface adhesively attached to first wall 102; first bottom indentation edge 142 is a foam cushioned surface adhesively attached to first wall 102, second top indentation edge 136 is a foam cushioned surface adhesively attached to second wall 104, and second bottom indentation edge 140 is a foam cushioned surface adhesively attached to second wall 104. These foam cushioned surfaces are capable of forming a watertight seal around a limb of a tree and also are capable of helping to hold rooter 100 in place while in use.

FIG. 2 also depicts second wall (interior) 148 and first wall (interior) 150. In said exemplary embodiment, second wall (interior) 148 is the interior side of second wall 104; and first wall (interior) 150 is the interior side of first wall 102.

In an exemplary embodiment, first wall 102, watering tube 108, first hinge 116, clasp reception block 120, clasp reception ridge 122, and first wall (interior) 150 are a solid form (i.e., in certain embodiments, formed from the same piece of PLA). Second wall 104, second hinge 118, rotating clasp block 124, rotating clasp bar 126, and second wall (interior) 148 are a solid form (i.e., in certain embodiments, formed from the same piece of PLA). Rotating clasp 128 and rotating clasp lip 130 are a solid form (i.e., in certain embodiments, formed from the same piece of PLA).

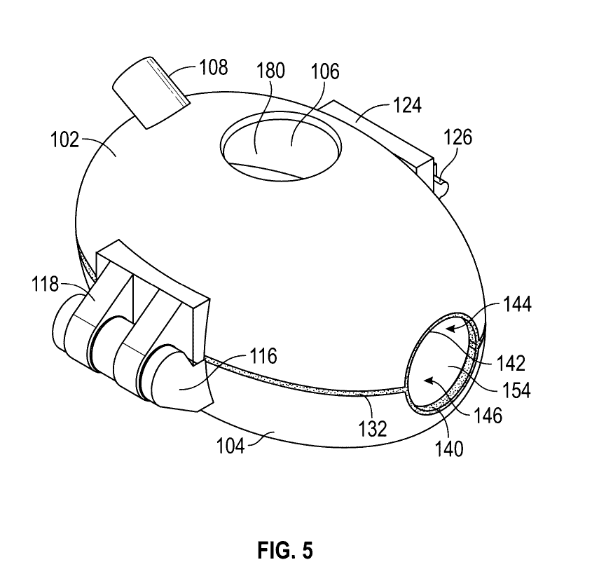

FIGS. 3, 4, and 5 depict said exemplary embodiment of rooter 100 when rooter 100 is closed. FIGS. 3 and 4 show the same features of rooter 100 as shown in FIGS. 1 and 2, but FIGS. 3 and 4 also depict top opening 152 and interior cavity 180 and FIG. 5 also depicts bottom opening 154.

In said exemplary embodiment of rooter 100, first wall 102 and second wall 104 rotate about the hinged connection between first hinge 116 and second hinge 118, with FIGS. 3, 4, and 5 depicting rooter 100 in a closed position, that is, a position having first edge 134 and second edge 132 touch. When rooter 100 is in a closed position, first top indentation 112 and second top indentation 114 form top opening 152; first bottom indentation 146 and second bottom indentation 144 form bottom opening 154; and first wall (interior) 150 and second wall (interior) 148 form interior cavity 180. First edge 134 and second edge 132 are approximately the same shape; thus, when rooter 100 is in a closed position, first edge 134 and second edge 132 are aligned. Top opening 152 and bottom opening 154 are each approximately circles of one inch in diameter, although other sized openings may be used.

In said exemplary embodiment, when rooter 100 is closed, top opening 152 and bottom opening 154 are on opposite sides of rooter 100; and top opening 152 and bottom opening 154 define a lengthwise axis through rooter 100. Clasp reception block 120 and rotating clasp block 124 are on a side of rooter 100 opposite first hinge 116 and second hinge 118; and clasp reception block 120 and rotating clasp block 124, on the one hand, and first hinge 116 and second hinge 118, on the other hand, define a second axis through rooter 100 which is orthogonal to the lengthwise axis through rooter 100.

In said exemplary embodiment, when rooter 100 is closed, rotating clasp 128 is capable of rotating and touching clasp reception ridge 122; and clasp reception ridge 122 is capable of receiving rotating clasp 128, thus locking rooter 100. Thus, clasp reception block 120, clasp reception ridge 122, rotating clasp block 124, rotating clasp bar 126, rotating clasp 128, and rotating clasp lip 130 create a locking mechanism. When rooter 100 is in a locked position, force is used to push rotating clasp lip 130 over clasp reception ridge 122, and rotating clasp lip 130 snaps in place parallel to clasp reception ridge 122. Thus, when rooter 100 is in a locked position, clasp reception ridge 122 and rotating clasp 128 (in particular, rotating clasp lip 130) push against each other to prevent first wall 102 and second wall 104 from rotating about the rotational connection of first hinge 116 and second hinge 118 (i.e., to prevent rooter 100 from moving from a closed, locked position to an open position). Other embodiments may include other types of locking mechanisms such as clasps, bolts, latches, or any other suitable type of fastener.

As discussed above, when rooter 100 is in a closed position, interior cavity 180 is formed. When rooter 100 is in a closed and locked position, the locking action creates pressure at first edge 134 and second edge 132. In embodiments where one or more of first edge 134 and second edge 132 comprise a cushioned surface, because first edge 134 and second edge 132 are aligned and are approximately the same shape, the pressure created by the locking action creates a watertight seal at first edge 134 and second edge 132.

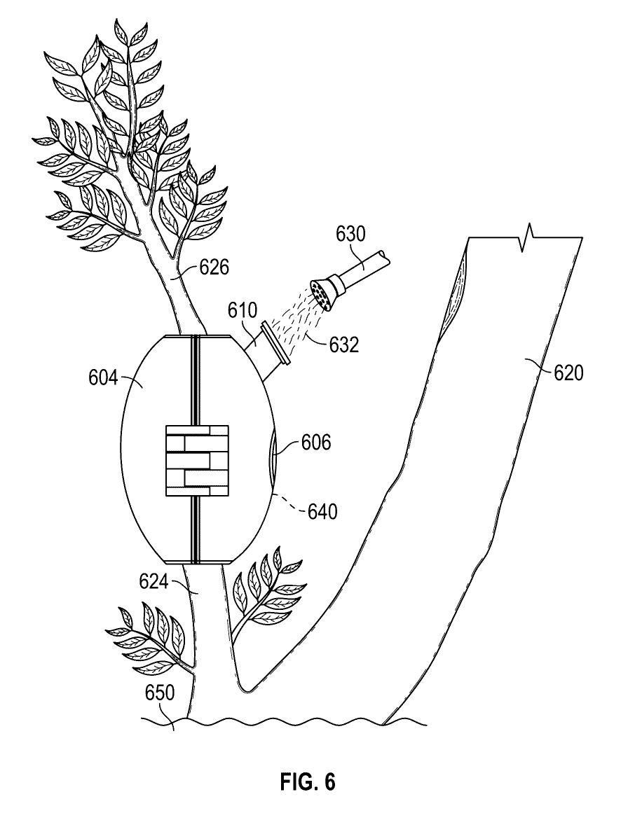

FIG. 6 illustrates exemplary embodiments of portions of rooting method 1000, further discussed in the discussion of FIG. 10. FIG. 6 illustrates rooter 604 in use on tree 620. Tree 620 may be any tree or plant which has the property of growing roots when covered in a mostly light-free, moist environment surrounded by a growing medium. Tree 620 is planted in soil 650. Soil 650 is any suitable soil where a tree or plant grows. In certain embodiments, rooter 604 is placed over a tree 620 at a point where the size of tree 620 causes rooter 604 to create a tight seal around tree 620. As depicted, rooter 604 is placed around a branch of tree 620, closed and clasped shut as described in the description of FIGS. 3-5, leaving branch bottom 624 and branch top 626 visible and exposed to the environment exterior to rooter 604.

Also depicted are viewing port 606 of rooter 604 and watering tube 610 of rooter 604, as well as watering device 630, water 632, root growth medium 640. Viewing port 606 may be used to visually inspect the interior of rooter 604, to water the interior of rooter 604, or to insert root growth medium 640 into the interior of rooter 604. Root growth medium 640 may also be placed inside the rooter 604 before the rooter 604 is closed around tree 620. Root growth medium 640 may be any suitable growth medium, including, without limitation, sphagnum moss or peat moss.

Watering device 630 is any suitable device for supplying water 632 to watering tube 610, which in turn supplies water 632 to the interior cavity 180 (not depicted) of rooter 604.

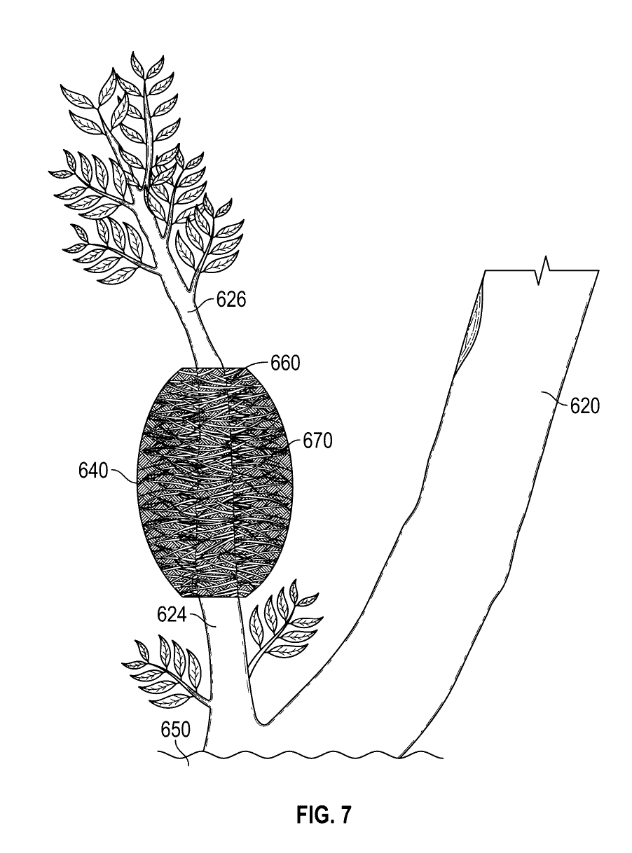

In exemplary embodiments, rooter 604 is applied in the fashion described above to tree 620, and the root growth medium 640 inside rooter 604 is kept moist through regular watering for approximately six to twelve weeks, or until sufficient roots grow from tree 620 into root growth medium 640. Root sufficiency is determined by the size of branch top 626. If branch top 626 is larger, more roots 670 (depicted in FIG. 7) must form in root growth medium 640 to be sufficient. Additionally, different types of plants may require more or less roots 670 in root growth medium 640.

FIG. 7 illustrates exemplary embodiments of portions of rooting method 1000, further discussed in the discussion of FIG. 10. FIG. 7 illustrates tree 620 after rooter 604 has been removed and roots 670 have grown into root growth medium 640 to create a root ball 660. Branch top 626 is shown above root ball 660, and branch bottom 624 is shown below root ball 660, with tree 620 remaining planted in soil 650.

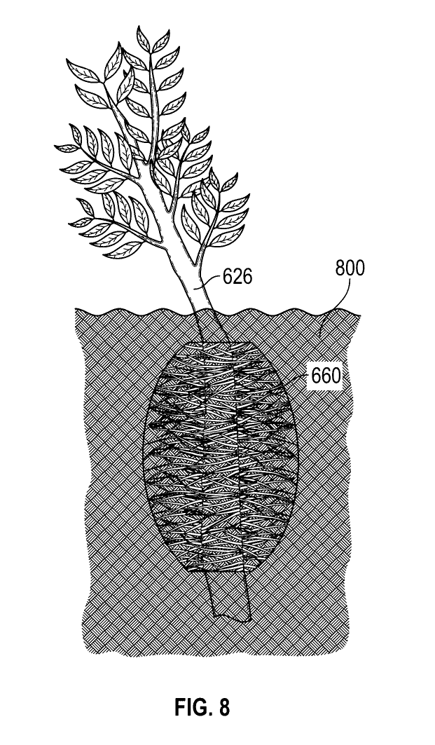

FIG. 8 illustrates exemplary embodiments of portions of rooting method 1000, further discussed in the discussion of FIG. 10. FIG. 8 illustrates that the performer or performers of rooting method 1000 have cut tree 620 at branch bottom 624, severing root ball 660 and branch top 626 from tree 620; and root ball 660 has been planted in alternate soil 800. Alternate soil 800 is in any suitable location and may be a different location than soil 650. As a result, root ball 660 is underground; but root ball 660 may also be planted in a pot filled with alternate soil 800.

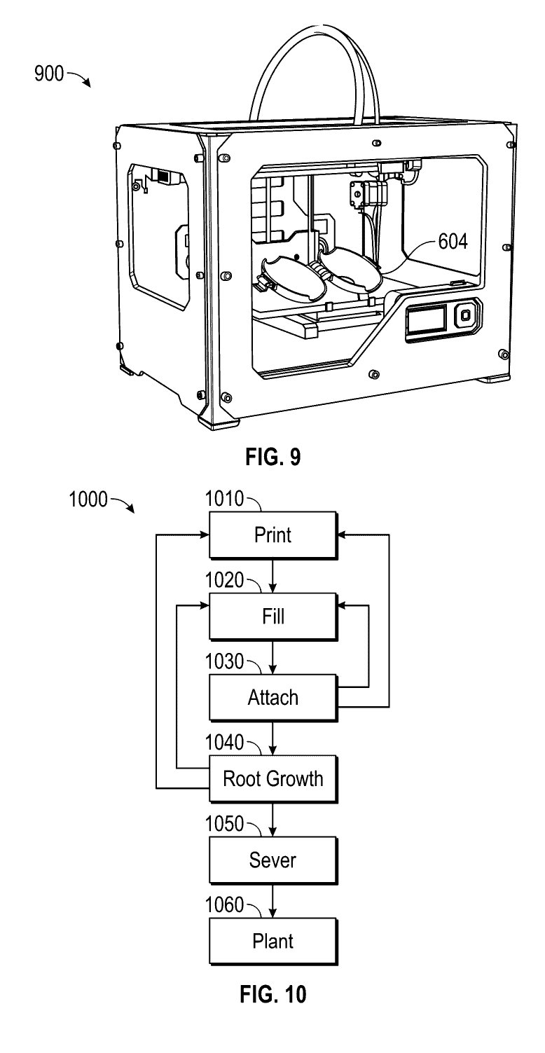

FIG. 9 illustrates exemplary embodiments of portions of rooting method 1000, showing three-dimensional printer 900 and rooter 910. In an exemplary embodiment, three-dimensional printer 900 is a Makerbot Replicator 2. Other embodiments can use different models of “three-dimensional printers,” that is, machines which are capable of additive manufacturing through the use of heated extruded polymers or plastics including, without limitation, acrylonitrile butadiene styrene (ABS), polycarbonate (PC), polylactic acid (PLA), high-density polyethylene (HDPE), PC/ABS, polyphenylsulfone (PPSU) and high impact polystyrene (HIPS). One skilled in the art would understand that the disclosed method may be performed by any three-dimensional printer capable of producing the device disclosed herein in varying sizes on demand. Other embodiments include injection molding or other types of molding, and varying sizes of rooter 910 may be achieved by using varying mold sizes.

Three-dimensional printer 900 can produce, or “print,” a rooter 910 in a range of sizes. Thus, if a performer of rooting method 1000 desires to use a rooter 910 on a larger tree or plant limb, rooter 910 can be printed in a larger size; alternatively, in a performer of rooting method 1000 desires to use a rooter 910 on a smaller tree or plant limb, rooter 910 can be printed in a smaller size. Thus, the size of rooter 910 can be scaled up or down as appropriate for its desired use.

FIG. 10 illustrates rooting method 1000.

In an exemplary embodiment of printing step 1010, branch top 626 and branch bottom 624 of tree 620 are examined to determine an appropriate size of rooter 604. Then, three-dimensional printer 900 is operated to create a rooter 604 in the desired appropriate size. Rooting method then proceeds to filling step 1020.

In an exemplary embodiment of filling step 1020, rooter 604 is filled with a root growth medium 640. Rooting method then proceeds to attaching step 1030.

In an exemplary embodiment of attaching step 1030, rooter 604 is closed around a tree 620 and is locked. An interior cavity 180 of rooter 604 may be observed through viewing port 606 to determine if additional root growth medium 640 is needed. If needed, additional root growth medium 640 may be added through viewing port 606. If significantly more root growth medium 640 is desired, rooting method 1000 may optionally unlock and open rooter 604 and proceed to filling step 1020. If rooter 604 is determined to be too large or too small for tree 620, rooting method 1000 may optionally unlock and open rooter 604 and return to printing step 1010. If no changes are desired, rooting method 1000 proceeds to root growth step 1040.

In an exemplary embodiment of root growth step 1040, water is added to rooter 604 through watering tube 610 or viewing port 606 such that root growth medium 640 is kept moist. During root growth step 1040, root growth medium 640 is monitored for the growth of a root ball 660. A root ball 660 generally grows in approximately six to twelve weeks. During root growth step 1040, additional root growth medium 640 may be added, if needed, through viewing port 606. If significantly more root growth medium 640 is desired, rooting method 1000 may optionally unlock and open rooter 604 and proceed to filling step 1020. If rooter 604 is determined to be too large or too small for tree 620, rooting method 1000 may optionally unlock and open rooter 604 and return to printing step 1010. After a root ball 660 forms, rooting method 1000 proceeds to severing step 1050.

In an exemplary embodiment of severing step 1050, the root ball 660 and branch top 626 are cut from tree 620. Rooting method 1000 then proceeds to planting step 1060.

In an exemplary embodiment of planting step 1060, root ball 660 is planted in alternate soil 800. After planting step 1060 is performed, root ball 660 will continue to grow in alternate soil 800 and branch top 626 will grow into a larger plant.

The foregoing description of the embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof as permitted as a matter of law.

Parts list

| | |
|---|---|
| 100 | Rooter |
| 102 | First wall |
| 104 | Second wall |
| 106 | Viewing port |
| 108 | Watering tube |
| 110 | Watering tube hole |
| 112 | First top indentation |
| 114 | Second top indentation |
| 116 | First hinge |
| 118 | Second hinge |
| 120 | Clasp reception block |
| 122 | Clasp reception ridge |
| 124 | Rotating clasp block |
| 126 | Rotating clasp bar |
| 128 | Rotating clasp |
| 130 | Rotating clasp lip |
| 132 | Second edge |
| 134 | First edge |
| 136 | Second top indentation edge |
| 138 | First top indentation edge |
| 140 | Second bottom indentation edge |
| 142 | First bottom indentation edge |
| 144 | Second bottom indentation |
| 146 | First bottom indentation |
| 148 | Interior of second wall |
| 150 | Interior of first wall |
| 152 | Top opening |
| 154 | Bottom opening |
| 180 | Interior cavity |
| 604 | Rooter |
| 606 | Viewing port |
| 610 | Watering tube |
| 620 | Tree |
| 624 | Branch bottom |
| 626 | Branch top |
| 630 | Watering device |
| 632 | Water |
| 640 | Root growth medium |
| 650 | Soil |
| 660 | Root ball |
| 670 | Roots |
| 800 | Alternate soil |
| 900 | 3D printer |
| 910 | Rooter |
| 1000 | Rooting Method |
| 1010 | Printing Step |
| 1020 | Filling Step |
| 1030 | Attaching Step |
| 1040 | Root Growth Step |
| 1050 | Severing Step |
| 1060 | Planting Step |

That which is claimed is:

1. A plant limb root germination apparatus, comprising a first wall and a second wall, said first wall further comprising, a first top indentation, a first bottom indentation, and a first edge; and said second wall further comprising a second top indentation, a second bottom indentation, and a second edge;
wherein said first wall and said second wall are hingedly connected on a first side and detachably connected on a second side; and
wherein when said first wall and said second wall are closed, said first wall and said second wall form an interior cavity, said first top indentation and said second top indentation form a top opening, and said first bottom indentation and said second bottom indentation form a bottom opening; wherein said interior cavity is capable of holding a root growth medium.

2. The plant limb root germination apparatus of claim 1, further comprising a locking mechanism which locks said first side and said second side together.

3. The plant limb root germination apparatus of claim 2, wherein said first wall and said second wall are rigid, opaque, and non-permeable to water.

4. The plant limb root germination apparatus of claim 3, wherein either said first edge or said second edge is a first cushioned surface.

5. The plant limb root germination apparatus of claim 4, wherein when said first wall and said second wall are locked together, said first cushioned surface creates a watertight seal between said first edge and said second edge.

6. The plant limb root germination apparatus of claim 5, wherein said first wall further comprises a viewing port and a watering tube.

7. The plant limb root germination apparatus of claim 6, wherein said first top indentation further comprises a first top indentation edge, said second top indentation further comprises a second top indentation edge, said first bottom indentation further comprises a first bottom indentation edge, and said second bottom indentation further comprises a second bottom indentation edge; and wherein each of said first top indentation edge, said second top indentation edge, said first bottom indentation edge, said second bottom indentation edge are cushioned surfaces.

8. A method of creating and using a plant limb root germination apparatus, comprising the steps of:
three-dimensionally printing a plant limb root germination apparatus comprising a first concave wall and a second concave wall, wherein said first concave wall and said second concave wall are hingedly and detachably connected and when closed form an interior cavity, a top opening, and a bottom opening;
filling said interior cavity of said plant limb root germination apparatus with a root growth medium;
attaching said plant limb root germination apparatus to a branch of a plant;
monitoring said root growth medium for root growth from said branch of said plant until a root ball forms in said root growth medium;
cutting said branch below said root ball; and
planting said root ball.

9. The method of claim 8, wherein said plant limb root germination apparatus is three dimensionally printed to dimensions appropriate for said branch of said plant.

10. The method of claim 9, wherein said plant limb root germination apparatus is rigid, opaque, and non-permeable to water.

11. The method of claim 10, wherein said first concave wall further comprises a viewing port and wherein said monitoring step further comprises adding an additional root growth medium into said interior cavity.

12. The method of claim 11, wherein said first concave wall further comprises a watering tube and said monitoring step further comprises a substep of maintaining moisture in said root growth medium in said interior cavity by adding water into said interior cavity by pouring water into said viewing port or said watering tube.

13. The method of claim 12, wherein said plant root limb germination apparatus further comprises a locking mechanism and said attaching step further comprises the step of locking said plant root limb germination apparatus.

14. The method of claim 13, wherein the step of locking said plant root limb germination apparatus securely fastens said plant root limb germination apparatus to said branch of said plant.
